(19) United States
(12) Patent Application Publication
(10) Pub. No.: US 2011/0133714 A1
(43) Pub. Date: Jun. 9, 2011

(54) POWER CONVERTER WITH PROTECTION MECHANISM FOR DIODE IN OPEN-CIRCUIT CONDITION AND PULSE-WIDTH-MODULATION CONTROLLER THEREOF

(76) Inventors: Chen-Min Chen, Hsin-Chu (TW); Ching-Tsan Lee, Hsin-Chu (TW); Yi-Shan Chu, Hsin-Chu (TW); Ming-Nan Chuang, Hsin-Chu (TW)

(21) Appl. No.: 13/030,100

(22) Filed: Feb. 17, 2011

Related U.S. Application Data
(62) Division of application No. 11/934,791, filed on Nov. 5, 2007.

(51) Int. Cl. G05F 1/10

(52) U.S. Cl. 323/283

(57) ABSTRACT

A power converter with a protection mechanism for a diode in an open-circuit condition includes a DC to Dc (DC/DC) conversion circuit, a detection and protection circuit, a pulse-width-modulation (PWM) signal generator, and a logic gate. The detection and protection circuit is used for detecting an open-circuit condition of the diode of the DC/DC conversion circuit. The logic gate receives an output signal of the detection and protection circuit and a PWM signal outputted by the PWM signal generator. When the diode is in an open-circuit condition, the PWM signal cannot be transmitted to a power switch of the DC/DC conversion circuit due to the output signal of the detection and protection circuit.

### CROSS REFERENCE TO RELATED APPLICATIONS

This divisional application claims the benefit of U.S. patent application Ser. No. 11/934,791, filed on Nov. 5, 2007 and incorporated herein by reference.

### BACKGROUND OF THE INVENTION

1. Field of the Invention

The present invention relates to a power converter, and more particularly, to a power converter with a protection mechanism for a diode in an open-circuit condition.

2. Description of the Prior Art

One of the prior art power converters is a boost DC-to-DC (DC/DC) converter 10, as shown in FIG. 1. When a power switch 104 is enabled, energy from an input voltage Vin at the input terminal is inputted to and stored in an inductor 102. When the power switch 104 is disabled, energy stored in the inductor 102 is transferred to the output terminal through a diode 106 to generate an output voltage Vo. However, it should be noted that when the diode 106 is in an open-circuit condition, there are no discharge paths for releasing the energy stored in the inductor 102 during the time when power switch 104 was enabled. Therefore, when the power switch 104 is disabled, a voltage drop Vds between drain and source terminals of the power switch 104 is represented as follows:

Vds=VL+Vin=L* d(IL)/dt+Vin

where VL is a voltage drop across the inductor 102 and a change rate of the induction current IL vs. time depends on the speed to disable the power switch 104. Additionally, a high value of the voltage drop VL across the inductor 102 usually damages the power switch 104. If it is desired to ensure that the power switch 104 can bear with such a high voltage drop VL without being damaged, using a high voltage-resistant Metal-Oxide-Semiconductor Field-Effect Transistor (MOSFET) as the power switch 104 or further adding a clamp protection circuit is necessary. The above-mentioned ways, however, will raise production costs, and the performance will therefore be decreased. Consequently, the following embodiments of the present invention disclose a method to improve the defects of the prior art power converters and, more specifically, to a protection circuit for preventing a diode of a boost DC/DC converter being in the open-circuit condition.

### SUMMARY OF THE INVENTION

The present invention provides a power converter with a protection mechanism for a diode in an open-circuit condition. The power converter comprises a DC/DC conversion circuit, a detection and protection circuit, a pulse-width-modulation (PWM) signal generator, and a logic gate. The DC/DC conversion circuit comprises an inductor, a power switch, and a first diode. The inductor is disposed at an input terminal of the DC/DC conversion circuit, and the power switch is electronically connected to the inductor. The first diode is electronically connected to the inductor and the power switch, and the PWM signal generator is utilized for generating a PWM signal to control a switching of the power switch.

According to one embodiment of the present invention, the detection and protection circuit includes a second electronic switch, a resistor, and a comparator, where a breakdown voltage of the second electronic switch is lower than that of the power switch. The logic gate receives an output signal of the comparator in the detection and protection circuit and the PWM signal. When the diode is in the open-circuit condition, the PWM signal cannot be transmitted to the power switch due to the output signal of the comparator.

The present invention can be used for detecting the first diode when the DC/DC conversion circuit is operating normally, to prevent the first diode from suddenly changing to the open-circuit condition. The first diode suddenly changing to the open-circuit condition will also cause damage to the power switch.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a prior art boost DC/DC converter.

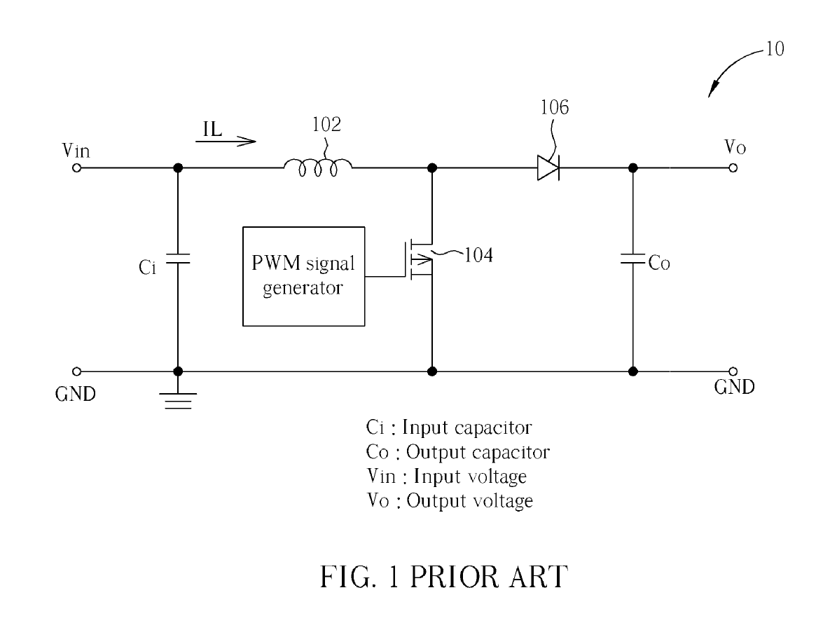

FIG. 2 is a diagram of a boost DC/DC converter according to a first embodiment of the present invention.

FIG. 3 is a diagram of a boost DC/DC converter according to a second embodiment of the present invention.

### DETAILED DESCRIPTION

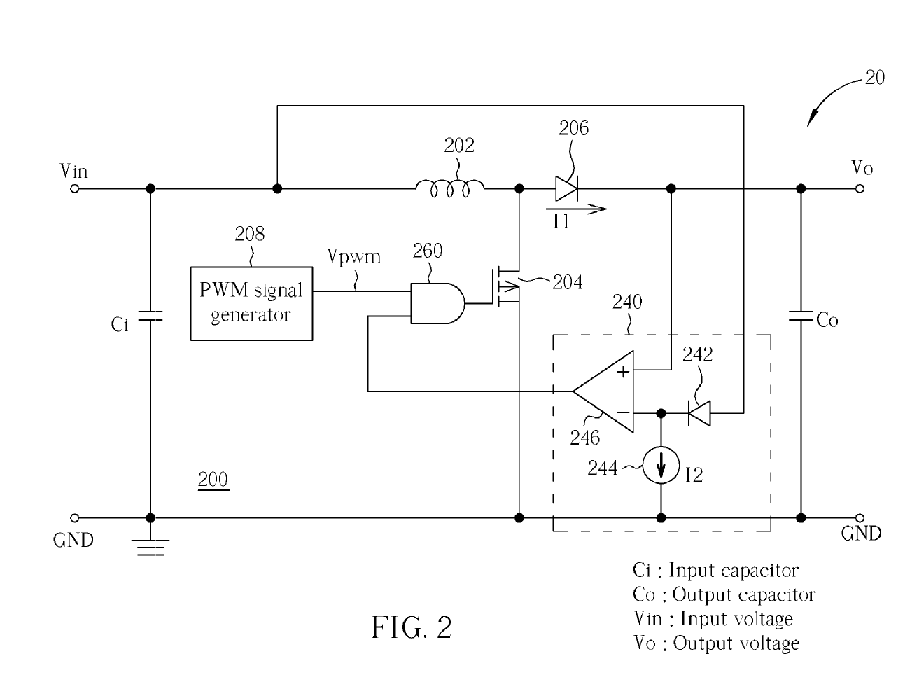

Please refer to FIG. 2, which illustrates a boost DC/DC converter 20 according to a first embodiment of the present invention. The boost DC/DC converter 20 comprises a DC/DC conversion circuit 200, a detection and protection circuit 240, a pulse-width-modulation (PWM) signal generator 208, and a logic gate 260. The DC/DC conversion circuit 200 comprises an inductor 202, a power switch 204, and a first diode 206. The inductor 202 is electronically connected to an input terminal of the DC/DC conversion circuit 200, and the power switch 204 is electronically connected to the inductor 202. The first diode 206 is electronically connected to the inductor 202 and power switch 204. The PWM signal generator 208 is utilized for generating a PWM signal Vpwm to control on/off switching of the power switch 204. The detection and protection circuit 240 comprises a second diode 242, a current source 244 providing a current I2, and a comparator 246. The logic gate 260 receives an output signal of the comparator 246 and the PWM signal Vpwm. When the first diode 206 is in the open-circuit condition, the PWM signal Vpwm cannot be transmitted to the power switch 204 due to the output signal of the comparator 246. The description is detailed in the following paragraphs.

A reference voltage at an inverting input terminal of the comparator 246 is equal to Vin−Vf2, and a voltage at a non-inverting input terminal of the comparator 246, i.e., a voltage Vo at the output terminal of the converter 20, is equal to Vin−Vf1. Here it is assumed that Vf2 and Vf1 are forward-bias voltage drops of the second diode 242 and first diode 206, respectively. After the power is activated, if the first diode 206 is in the open-circuit condition, the voltage at the non-inverting input terminal of the comparator 246 (i.e., the voltage Vo) becomes zero and the voltage at the inverting input terminal of the comparator 246 equals Vin−Vf2. Accordingly, the output signal of the comparator 246 can be maintained at a low logic level. The logic gate 260 then receives the output signal of the comparator 246 so that the PWM signal Vpwm outputted by the PWM signal generator 208 cannot be transmitted to the power switch 204. Since the on/off switching of the power switch 204 cannot be operated normally, no energy is stored in the inductor 202 and also no voltage spikes arise in the power switch 204.

Otherwise, after activating the power, if the first diode 206 operates normally, the voltage Vo, i.e., a voltage used for charging an output capacitor Co, at the non-inverting input terminal of the comparator 246 will increase since the output capacitor Co will be charged and become saturated rapidly. In this situation, because the current I2 flowing through the second diode 242 is considerably larger than the current I1 flowing through the first diode 206, the forward-bias voltage drop Vf2 of the second diode 242 becomes much higher than that (i.e., Vf1) of the first diode 206. This will cause that voltage Vin−Vf1 at the non-inverting input terminal of the comparator 246 to be higher than the voltage Vin−Vf2 at the inverting input terminal of the comparator 246. The output signal of the comparator 246 therefore changes to a high logic level. The logic gate 260 then receives the output signal of the comparator 246, and the PWM signal Vpwm outputted by the PWM signal generator 208 is transmitted to the power switch 204. Thus, the power switch 204 can operate correctly.

As mentioned above, the first embodiment of the present invention is used for detecting the first diode 206 when the power is initially activated, to prevent the first diode 206 from being floating due to open solder or other factors. The first diode 206 being floating will cause damage to the power switch 204. The current source 244 of this embodiment can be replaced by a resistor. In addition, the PWM signal generator 208, detection and protection circuit 240, and the logic gate 260 shown in the first embodiment of the present invention can be integrated in a PWM controller, which is usually an aspect of a chip design. Even the power switch 204 can also be integrated within the PWM controller.

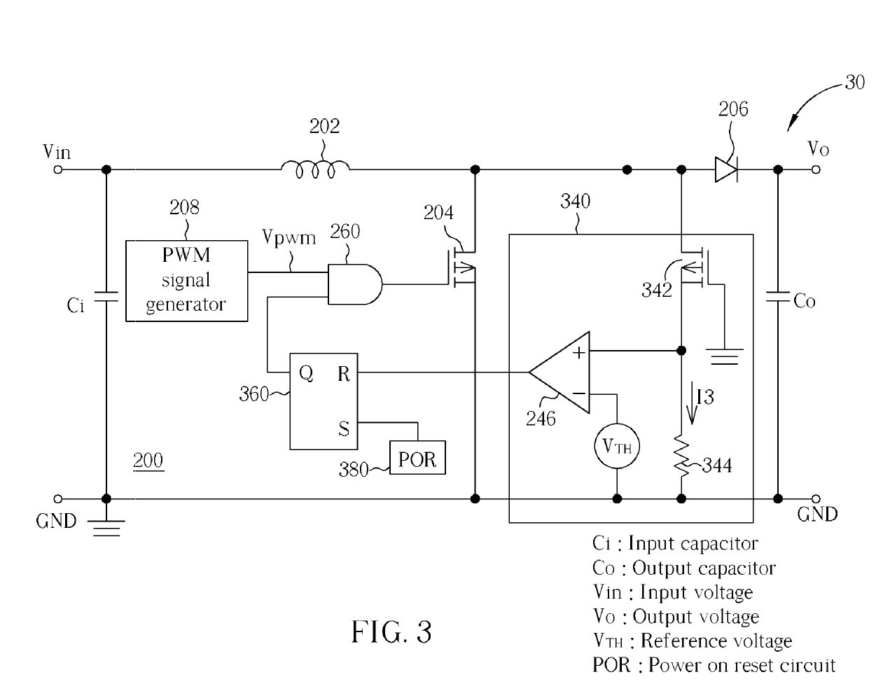

Please refer to FIG. 3, which illustrates a boost DC/DC converter 30 according to a second embodiment of the present invention. In this embodiment, in addition to a DC/DC conversion circuit 200, a detection and protection circuit 340, a PWM signal generator 208, and a logic gate 260, the boost DC/DC converter 30 further includes a flip-flop 360 and a power on reset (POR) circuit 380. The detection and protection circuit 340 comprises a second electronic switch 342, a resistor 344, and a comparator 246. The second electronic switch 342 is electronically connected to an anode terminal of the first diode 206 and the inductor 202. Two ends of the resistor 344 are electronically connected to a ground level and the second electronic switch 342, respectively. One input terminal of the comparator 246 is electronically connected to the second electronic switch 342 and the resistor 344 while another input terminal of the comparator 246 is electronically connected to a reference voltage VTH. The flip-flop 360 has set and reset input terminals S and R, where the reset input terminal R is electronically connected to the output terminal of the comparator 246 and the set input terminal S is electronically connected to an output terminal of the power on reset circuit 380. The output terminal of the flip-flop 360 is electronically connected to the input terminal of the logic gate 260. The description of the operation of the boost DC/DC converter 30 is detailed as follows.

The second electronic switch 342 has a drain-to-source breakdown voltage, which is lower than the breakdown voltage of the above-mentioned power switch 204 and utilized for predicting whether the power switch 204 is inclined to breakdown.

A current I3 flows through the second electronic switch 342 and the resistor 344 when the second electronic switch 342 breakdowns. One can design the value of the resistor 344 so that the result of the current I3 multiplied by the resistor 344 can be equal to or higher than the reference voltage VTH. Thus, the output signal of the comparator 246 changes to the high logic level when the second electronic switch 342 breakdowns, and this output signal is received by the flip-flop 360 at the reset input terminal R. Next, the output signal of the flip-flop 360 changes to the low logic level and is latched at this low logic level. The logic gate 260 receives the output signal of the flip-flop 360, and then the PWM signal outputted by the PWM signal generator 208 cannot be transmitted to the power switch 204; the on/off switching of the power switch 204 is disabled so that the inductor 202 will not store energy continuously. Therefore, the power switch 204 is protected.

After ensuring that the failure of the first diode 206 being in the open-circuit condition has been excluded, it can be achieved by using the power on reset circuit 380 to output a signal having the high logic level to reset the flip-flop 360. The output signal of the flip-flop 360 changes to the high logic level, and then this output signal is transmitted to the logic gate 260. By doing this, the PWM signal Vpwm outputted by the PWM signal generator 208 is transmitted to the power switch 204 so that the on/off switching of the power switch 204 operates normally.

As mentioned above, the second embodiment of the present invention can be used for detecting the first diode 206 when the DC/DC conversion circuit 200 operates normally, to prevent the first diode 206 from suddenly changing to the open-circuit condition. The first diode 206 suddenly changing to the open-circuit condition will cause damage to the power switch 204. Additionally, in this embodiment, the PWM signal generator 208, the detection and protection circuit 340, the flip-flop 360, the power on reset circuit 380, and the logic gate 260 can be integrated to be a PWM controller, which is usually an aspect of a chip design. Even the power switch 204 can also be integrated within the PWM controller.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A power converter with a protection mechanism for a diode in an open-circuit condition, comprising:
a boost DC-to-DC (DC/DC) conversion circuit, comprising:
an inductor, disposed at an input terminal of the boost DC/DC conversion circuit;
a power switch, electronically connected to the inductor; and
a first diode, electronically connected to the inductor and the power switch;
a pulse-width-modulation (PWM) signal generator, for generating a PWM signal to control a switching of the power switch;
a detection and protection circuit, for detecting whether the first diode is in an open-circuit condition, comprising:
a second electronic switch, electronically connected to an anode terminal of the first diode and the inductor;
a resistor having two ends, one end being electronically connected to a ground level and the other end being electronically connected to the second electronic switch; and
a comparator having two input terminals, one input terminal being electronically connected to the second electronic switch and the resistor, and the other input terminal being electronically connected to a reference voltage; and
a logic gate, for receiving an output signal of the detection and protection circuit and the PWM signal, wherein the PWM signal is not transmitted to the power switch due to the output signal of the detection and protection circuit when the first diode is in the open-circuit condition.

2. The power converter of claim 1, wherein a breakdown voltage of the second electronic switch is lower than a breakdown voltage of the power switch.

3. The power converter of claim 1, further comprising:
a flip-flop having a set input terminal and a reset input terminal, the reset input terminal being electronically connected to an output terminal of the comparator; and
a power on reset circuit having an output terminal electronically connected to the set input terminal of the flip-flop, wherein an output terminal of the flip-flop is electronically connected to an input terminal of the logic gate.

4. A pulse-width-modulation (PWM) controller applied to a boost DC-to-DC (DC/DC) converter with a protection mechanism for a diode in an open-circuit condition, the boost DC/DC converter including the PWM controller, an inductor, a power switch, and a first diode, and the PWM controller comprising:
a PWM signal generator, for generating a PWM signal to control a switching of the power switch;
a detection and protection circuit, for detecting whether the first diode is in the open-circuit condition, comprising:
a second electronic switch, electronically connected to an anode terminal of the first diode and the inductor;
a resistor having two ends, one end being electronically connected to a ground level and the other end being electronically connected to the second electronic switch; and
a comparator having two input terminals, one input terminal being electronically connected to the second electronic switch and the resistor, and the other input terminal being electronically connected to a reference voltage; and
a logic gate, for receiving an output signal of the detection and protection circuit and the PWM signal, wherein the PWM signal is not transmitted to the power switch due to the output signal of the detection and protection circuit when the first diode is in the open-circuit condition.

5. The PWM controller of claim 4, wherein a breakdown voltage of the second electronic switch is lower than a breakdown voltage of the power switch.

6. The PWM controller of claim 4, wherein the boost DC/DC converter further comprises:
a flip-flop having a set input terminal and a reset input terminal, the reset input terminal being electronically connected to an output terminal of the comparator; and
a power on reset circuit having an output terminal electronically connected to the set input terminal of the flip-flop, where an output terminal of the flip-flop is electronically connected to an input terminal of the logic gate.
